(19) United States
(12) Patent Application Publication
(10) Pub. No.: US 2025/0350100 A1
(43) Pub. Date: Nov. 13, 2025

(54) CONTROLLABLE BIPOD SYSTEM FOR POSITIONING OF ELONGATED POLE

(71) Applicant: Florida Power & Light Company, Juno Beach, FL (US)

(72) Inventors: KYLE A. BUSH, Palm Beach Gardens, FL (US); TEODORO GONZALEZ, Pembroke Pines, FL (US); SCARLETT LUIS, Juno Beach, FL (US); PETER B. DURKIN, Davie, FL (US); CHASE M. CAPICOTTI, Port St. Lucie, FL (US); HUNTER A. LAZENBY, Opelika, AL (US); BENJAMIN T. SMITH, Huntsville, AL (US); ANDREW D. WELCH, Brewton, AL (US); SAMUEL P. HENDRIXSON, Cumming, AL (US); JAMES A. SINGLETON, Baton Rouge, LA (US); LOGAN K. WILLIAMS, Buford, GA (US); HALLE J. BOSO, Moody, AL (US)

(21) Appl. No.: 18/659,518

(22) Filed: May 9, 2024

(51) Int. Cl. H02G 1/02; H02K 41/02; H02P 29/00

(52) U.S. Cl. CPC H02G 1/02; H02K 41/02; H02P 29/00

(57) ABSTRACT

Bipod systems for maneuvering elongated poles and methods of using such systems are discussed. One example is a bipod system, comprising a first leg comprising a first actuator configured to change the length of the first leg in response to a first control signal, wherein changing the length of the first leg moves the elongated pole in a first direction; a second leg comprising a second actuator configured to change the length of the second leg in response to a second control signal, wherein changing the length of the second leg moves the elongated pole in a second direction that is different from the first direction; a connector configured to secure an elongated pole to the bipod system; and a controller configured to generate the first control signal and the second control signal in response to a user input.

### TECHNICAL FIELD

This invention relates to assistive devices for maneuvering an elongated pole, in particular, to a bipod system that allows automated control over the position of an upper end of an elongated pole.

### BACKGROUND

In the field of power distribution systems, there are many time-consuming and cumbersome tasks that fill the typical day of a line worker or maintenance personnel. One of these tasks is replacing blown fuses on distribution power lines. The multistep process involves using a long “extendo” pole (telescopic hot stick) that may be extended to up to forty feet. This pole can include a small hook on the end that is used to lift the hanging fuse barrel out of its hooks and free it from the power pole. The extendo pole can then manually be collapsed back down to the original size so that the operator can grab the fuse barrel, replace the blown fuse inside of it, and repeat the extending/collapsing process to replace the fuse on the power line, only this time the fuse can be reconnected to the live current. Maneuvering this tall pole can be difficult to do precisely and can be strenuous for the user. Additionally, some conditions such as high winds can make the process more difficult, increasing the time and exertion from the line worker.

### SUMMARY OF THE INVENTION

In one implementation, a bipod system is provided. The bipod system includes a first leg including a first actuator configured to change the length of the first leg in response to a first control signal. The bipod system additionally includes a second leg including a second actuator configured to change the length of the second leg in response to a second control signal. The bipod system also includes a connector configured to secure an elongated pole to the bipod system. The bipod system further includes a controller configured to generate the first control signal and the second control signal in response to a user input.

In another implementation, a method is provided. The method includes extending a telescopic hot stick while secured to an adjustable bipod system, wherein the telescopic hot stick and the adjustable bipod system form a tripod. The method also includes maneuvering an upper end of the telescopic hot stick into a target region via adjusting at least one of a first length of a first leg of the adjustable bipod system or a second length of a second leg of the adjustable bipod system. The method additionally includes performing an operational function with the upper end of the telescopic hot stick in the target region. The method further includes retracting the telescopic hot stick while secured to the adjustable bipod system.

In a further implementation, a bipod system is provided. The bipod system includes a first leg including a first actuator configured to change the length of the first leg in response to a first control signal. The bipod system additionally includes a second leg including a second actuator configured to change the length of the second leg in response to a second control signal. The bipod system also includes an elongated pole that is secured to the bipod system via a connector. The bipod system further includes a controller configured to generate the first control signal and the second control signal in response to a user input.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 illustrates a diagram showing an example bipod system with two legs having lengths that are adjustable based on user inputs to maneuver a telescopic hot stick in connection with powerline maintenance.

FIG. 2 illustrates an example bipod system that attaches near the lower end of a pole to form a tripod capable of maneuvering the upper end of the pole.

FIG. 3 illustrates a diagram showing components of an example bipod system.

FIG. 4 illustrates a flowchart of an example method for using an adjustable bipod system to maneuver the upper end of a telescopic hot stick to perform powerline maintenance tasks.

### DETAILED DESCRIPTION

Various examples described herein include a controllable bipod system for maneuvering an elongated pole and methods of employing such a controllable bipod system. Examples increase the efficiency of processes involving maneuvering elongated poles, such as replacement of blown fuses on power lines, trimming of vegetation with a pole saw, etc. While examples are employable in connection with multiple different types of elongated poles employed for a wide variety of tasks, for purposes of illustration, examples are discussed in connection with maneuvering a telescopic hot stick (“extendo pole”) for replacing a blown fuse on a distribution power line.

Various examples allow for steering of an extendo pole when extended, providing extra relief for line workers that routinely perform fuse replacement tasks several times a day, which can be very tiresome on the shoulders of line-workers. At full length, the pole can be difficult to line up with the fuse, leading to an extended time spent moving the pole back and forth with the arms of the worker held up high. More difficulty can arise on days that have gusty winds, leading to extra swaying and applied torque on the pole. Examples provide a powered device that helps to control the pole and reduces the load on the shoulders of the line-worker, curtailing muscle strain on the line-worker, allowing for the same or a greater number of fuse replacements to be performed in a day than conventional systems and methods, with substantially reduced fatigue on the line-worker. Additionally, the reduced reliance on the strength of the line-worker allows a wider range of people to perform the task.

Examples include bipod assist robots and methods of using bipod assist robots to maneuver an extendo stick that improve the efficiency of swapping out blown fuses on distribution power lines in the field. The conventional method for swapping a blown fuse involves using a fiberglass extendo stick with multiple sections that manually extend out and lock into place, reaching as far as forty feet, and is manually maneuvered to perform fuse replacement. While this is the accepted method in the industry, there is room for improvement. It is a difficult and delicate process to move the end of the extendo stick to hook the small loop on the fuse used to remove and replace it. The conventional procedure leads to a strenuous, time consuming, and potentially risky maneuver to replace blown fuses.

Examples address the most time consuming and strenuous part of the process: manually controlling the long pole with or without a fuse on the end of it. To improve this process, examples include or employ a bipod system capable of manipulating the position of the end of the pole by adjusting the lengths of the legs of the bipod (e.g., via a system of linear actuators, etc.) based on user inputs (e.g., received via a joystick, soft controls on a touch screen of a mobile device, etc.). As a result, examples reduce manual operation of the pole and the resulting back and neck strain on a line-worker as the pole begins to lean over at long lengths and/or in windy situations. Examples also curtail jostling around while a worker extends the pole back up to the fuse mount when there is a fuse hanging on the extendo stick.

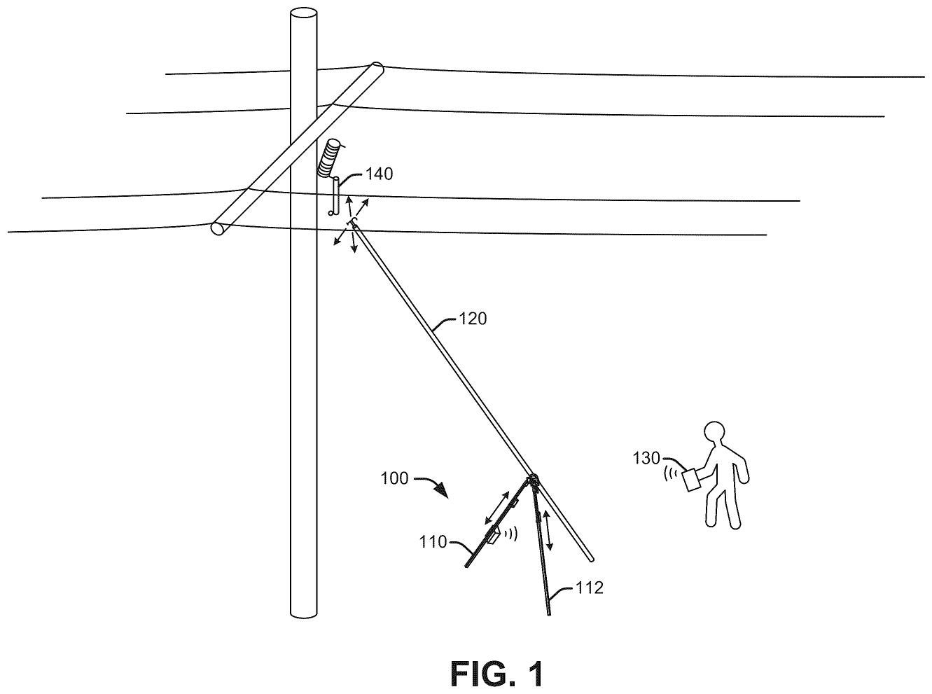

Referring to the example of FIG. 1, illustrated is a diagram showing an example bipod system 100 with two legs 110 and 112 having lengths that are adjustable based on user inputs to maneuver an extendo pole 120 in connection with powerline maintenance. In various examples, a user can provide user inputs to maneuver an upper end of the extendo pole via an input device attached to the bipod system 100 and/or a remote input device 130. In some examples, the input device (e.g., a local input device, the remote input device 130, etc.) includes physical control features that facilitate the user input as manual user inputs, such as button(s), lever(s), single or multi-axis joystick(s) (e.g., of any of a variety of sizes such as thumb-controllable joystick(s) or hand-controllable joystick(s)), etc. In the same or other examples, the input device includes a touchscreen or other soft controls that receive user inputs as touches and/or gestures to control the lengths of the legs 110 and 112. Additionally or alternatively, in various examples the input device outputs feedback to the user, such as feedback (e.g., from a camera, distance sensor, etc.) regarding the position of the upper end of the extendo pole 120.

The bipod system 100 can secure the extendo pole 120 to the bipod system 100 to form a tripod with the extendo pole 120 as the third leg. As an example, the weight of the extendo pole 120 can support the legs of the bipod device, but other means of weighing down or stabilizing the tripod formed by the bipod system 100 and the extendo pole 120 can be implemented (e.g., weights, stakes, etc.). Each of the leg 110 and the leg 112 of the bipod system 100 is independently controllable, allowing an operator to maneuver an upper end of the extendo pole 120 into position to replace a blown fuse (e.g., fuse 140) or perform other tasks. However, in various examples, instead of directly controlling the lengths of the leg 110 and/or the leg 112, user inputs are provided (e.g., via a dual axis joystick, etc.) as motion along orthogonal directions (e.g., up/down and left/right, etc.), and translated into the appropriate length adjustments for the leg 110 and/or the leg 112 (e.g., upward motion involving increasing the length of both of the leg 110 and the leg 112, downward motion involving decreasing the length of both the leg 110 and the leg 112, and left/right motion involving increasing the length of one of the leg 110 or the leg 112 and decreasing the length of the other of the leg 110 or the leg 112, etc.). In some examples, the square grid coordinates of a joystick are mapped to a circle in order to use polar coordinates to determine direction and speed of movement.

The position of the bottom end of the extendo pole 120 can be fixed on the ground as one of three legs of a tripod (along with the legs 110 and 112 of the bipod system 100). The bottom end of the extendo pole 120 can act as the fulcrum of a third class lever, with forces applied by the system 100 at the connection point between the system 100 and the extendo pole 120 to move the upper end of the extendo pole 120 into position to perform tasks (e.g., removing a blown fuse, installing a new fuse, etc.). Changing the length of either or both of the legs 110 and/or 112 rotates the extendo pole 120 around the bottom end of the extendo pole 120, moving the upper end of the extendo pole 120 along the surface of a sphere with a radius equal to the length of the extendo pole 120, an area that is substantially planar for small variations in the lengths of the legs 110 and/or 112.

By adjusting the lengths of the legs 110 and/or 112 of the bipod system 100, the upper end of the extendo pole 120 can be controlled to perform powerline maintenance tasks, such as removal of a blown fuse or installation of a new fuse. In various examples, the extendo pole 120 is any of a variety of conventional extendo poles, which are secured to the bipod system via a connector such as a clasp that opens to allow placement of the extendo pole 120 within and closes to secure the extendo pole 120 to the bipod system 100.

Various examples of the bipod system 100 are employable in connection with conventional extendo poles as the extendo pole 120, allowing the same equipment to be used by a wider range of workers, with less strain on the worker, and precise control in a wide range of scenarios, in turn allowing more powerline maintenance work to be accomplished in a day by a worker. Additionally or alternatively, various examples are employable in connection with various other poles as the extendo pole 120, including self-extending or self-telescoping poles such as a pole extendable via a pulley system, a pneumatic system, a linear actuator, a rotary motor that drives linear motion of the pole such as via a rack and pinion or via friction between a wheel and linear member, etc., allowing for automated extension or retraction of the pole via the input device 130 based on a control signal generated in response to a user input instead of manual extension, etc.

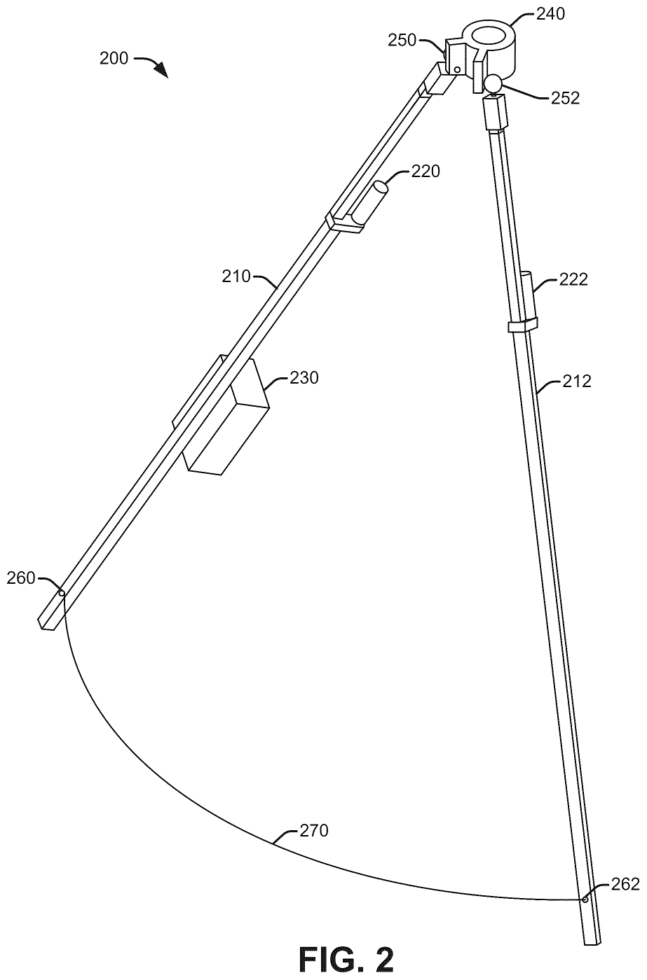

Referring to the example of FIG. 2, illustrated is an example bipod system 200 (e.g., employable as the bipod system 100 in various examples, etc.) that attaches near the lower end of a pole (e.g., the extendo pole 120 in various examples, etc.) to form a tripod capable of maneuvering the upper end of the pole.

The bipod system 200 includes a first leg 210 and a second leg 212, the lengths of which are controlled by a first linear actuator 220 and a second linear actuator 222, respectively. The linear actuators 220 and 222 can adjust the lengths of the legs 210 and 212, respectively, in response to control signals received from a controller 230, which generates the control signals for the linear actuators 220 and/or 222 in response to user inputs received from a user interface (not shown) that communicates with the controller 230 via a wired or wireless connection, depending on the example. In various examples, power for the controller 230 and the linear actuators 220 and 222 is provided by one or more rechargeable and/or removable batteries. Electrical components of the bipod system 200 (e.g., the controller 230, the linear actuators 220 and 222, any power supply such as one or more batteries) are well insulated and able to withstand harsh weather conditions for use in the field in various types of weather.

The bipod system 200 also includes a connector 240 that secures the pole (e.g., extendo pole 120, etc.) to the bipod system. Various connectors are used as the connector 240 in various examples, such as a clasp that opens and closes around the pole to secure the pole to the bipod system 200. The connector 240 is coupled to the legs 210 and 212 via ball joints 250 and 252, respectively, that allow the connector 240 to rotate on multiple axes relative to each of the legs 210 and 212. In some examples, the connector 240 is capable of connecting with any of a variety of telescopic hot sticks (e.g., conventional extendo sticks of various designs, etc.). In other examples, the connector 240 permanently secures an extendo stick to the bipod system 200 as an integral part of a tripod comprising the bipod system 200 and the extendo stick (e.g., an extendo stick designed to be automatically extended in response to user inputs, etc.). In some such examples, the extendo stick is automatically extended or retracted based on a control signal generated from the controller 230 that activates a pulley system, a pneumatic system, a linear actuator, a rotary motor that drives linear motion of the pole such as via a rack and pinion or via friction between a wheel and linear member, etc.

In various examples, each of the legs 210 and 212 includes a connection point 260 and 262, respectively, to attach a length of flexible material 270 (e.g., chain, rope, cable, wire, etc.) that limits the maximum distance between the bottom of the legs 210 and 212 and the maximum angle between the legs 210 and 212 of the bipod system 200. This allows the bipod system 200 to remain upright when deployed and to collapse for transport.

In various examples, the bipod system 200 is made from lightweight materials (e.g., carbon fiber, etc.) that allow an average person to lift and carry the potentially long distances involved in powerline maintenance (e.g., on some occasions, line-workers will need to walk half a mile or more to reach fuses, etc.). The connector (e.g., a clasp) 240 can secure and support various conventional extendo poles (e.g., with circular cross-section, triangular cross-section, etc.). The bipod system 200 can be stored (e.g., with the legs 210 and 212 folded together) in a bucket truck commonly used in connection with powerline maintenance and used portable rechargeable batteries compatible with handheld power drills.

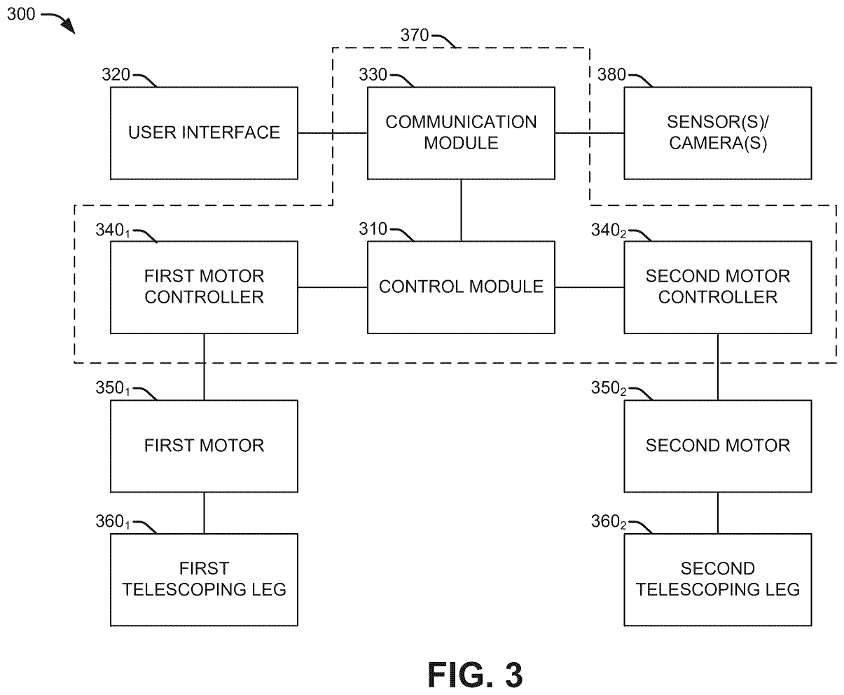

Referring to the example of FIG. 3, illustrated is a diagram showing components of an example bipod system 300 (e.g., employable as the bipod system 100 and/or the bipod system 200 in some examples). A control module 310 receives user inputs from a user interface 320 via a communication module 330 (e.g., over a wired or wireless connection, etc.). Based on the user inputs, the control module 310 controls a first motor controller 340 and/or a second motor controller 342 to drive a first motor (e.g., linear actuator, etc.) 350 and/or a second motor (e.g., linear actuator, etc.) 352, respectively. In some examples, the control module 310 additionally controls extension or retraction of an automatically telescoping extendo pole connected to the bipod system 300 (e.g., via a connector such as the connector 240, etc.) via a pulley system, a pneumatic system, a linear actuator, a rotary motor that drives linear motion of the pole such as via a rack and pinion or via friction between a wheel and linear member, etc. The first motor 350 and the second motor 352 increase or decrease the length of the first (e.g., right or left) telescoping leg 360 or the second telescoping leg 362 (e.g., left or right), respectively. In some examples, the control module 310, the communication module 330, and the motor controllers 340 and 342 are separate components, while in other examples the control module 310, the communication module 330, and the motor controllers 340 and 342 are included within a controller 370 (e.g., controller 230, etc.).

In various examples, one or more sensors or cameras 380 provide user feedback (e.g., either directly or via a display of the user interface 320, etc.) regarding the position of the upper end of the elongated pole and are communicatively coupled to the control module 310 via the communication module 330. In some examples, the sensor(s) and/or camera(s) 380 include a camera aligned with the pole (e.g., attached to a connector (e.g., clasp) of the bipod system 300 and/or the pole, such as at an upper portion of the pole, etc.), which provides a view of a target region (e.g., output to the user interface 320, etc.) for maneuvering the upper end of the pole displayed via the user interface 320. In these or other examples, the sensor(s) and/or camera(s) 380 include a laser sight or laser pointer aligned with the pole (e.g., attached to a connector or the pole) that provides direct user feedback via a visual indication of where the pole is pointed or located. In the same or other examples, the sensor(s) and/or camera(s) include a distance sensor that senses a distance between the tip of the pole and an object in front of the pole (e.g., or a distance from which the distance between the tip of the pole and the object in front of the pole can be determined, such as a distance having a fixed offset to the relevant distance, etc.).

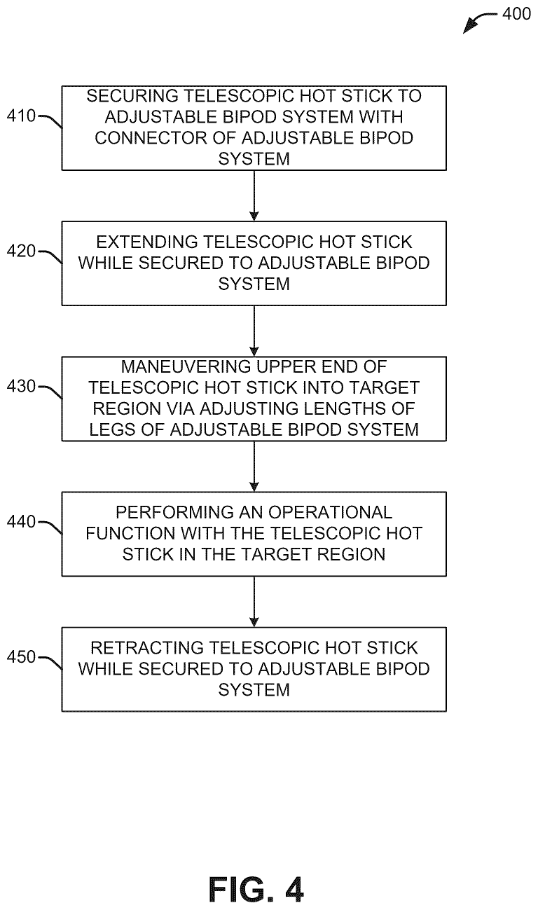

In view of the foregoing structural and functional features described above, an example method will be better appreciated with reference to the example of FIG. 4. While, for purposes of simplicity of explanation, the example method of the example of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 4 illustrates a flowchart of an example method 400 for using an adjustable bipod system to maneuver the upper end of a telescopic hot stick (e.g., extendo pole) to perform powerline maintenance tasks (e.g., removing a blown fuse, installing a new fuse, etc.). In other examples, one or more of the blocks of example method 400 are a set of machine-readable instructions on a non-transitory machine-readable medium or are a set of operations performed by a processor executing machine-readable instructions as the operations.

At block 410, method 400 includes securing the telescopic hot stick to the adjustable bipod system via a connector (e.g., clasp, etc.) of the adjustable bipod system.

At block 420, method 400 includes extending the telescopic hot stick while it is secured to the adjustable bipod system. In some examples (e.g., with a conventional telescopic hot stick), the telescopic hot stick is extended manually. In other examples, the telescopic hot stick is extended automatically in response to user input.

At block 430, method 400 includes maneuvering the upper end of the telescopic hot stick into a target region (e.g., to remove a blown fuse, to install a new fuse, etc.) via adjusting the lengths of the legs of the adjustable bipod system in response to user inputs.

At block 440, method 400 includes performing an operational function in the target region with an upper end of the telescopic hot stick. In various examples, the operational function is removing a blown fuse, installing a replacement fuse, disconnecting a fuse, or one or more other powerline maintenance tasks.

At block 450, method 400 includes retracting the telescopic while secured to the adjustable bipod system.

In some examples, blocks 410-440 are performed a single time, while in other examples one or more blocks are repeated. As one example of the latter, blocks 410-440 are performed a first time to remove a blown fuse, and blocks 420-440 are repeated to install a new fuse to replace the blown fuse.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Also as used herein, the term “set” means one or more elements (e.g., where the elements can be anything, such as datasets, nodes, relationships, etc.), and a “subset” of a set A refers to any set B where every element of set B is an element of set A (note that every set A is a subset of itself, as every element of set A is an element of set A). Similarly, a “proper subset” of set A refers to a set B that is a subset of set A but does not include every member of set A, such that set A and set B are not equal. Additionally, where the disclosure or claims recite “a,” “an,” “a first,” or “another” element, or the equivalent thereof, it should be interpreted to include one or more than one such element, neither requiring nor excluding two or more such elements.

In this description, unless otherwise stated, “about,” “approximately” or “substantially” preceding a parameter means being within +/−10 percent of that parameter. Modifications are possible in the described embodiments, and other embodiments are possible, within the scope of the claims.

What is claimed is:

1. A bipod system, comprising:
a first leg comprising a first actuator configured to change the length of the first leg in response to a first control signal;
a second leg comprising a second actuator configured to change the length of the second leg in response to a second control signal;
a connector configured to secure an elongated pole to the bipod system; and
a controller configured to generate the first control signal and the second control signal in response to a user input to move the elongated pole based on a change to the length of at least one of the first leg and the second leg.

2. The bipod system of claim 1, wherein the first actuator is a first linear actuator and the second actuator is a second linear actuator.

3. The bipod system of claim 1, wherein the first leg is coupled to the connector by a first ball joint and the second leg is coupled to the connector by a second ball joint.

4. The bipod system of claim 1, further comprising a flexible tether interconnecting the first leg and the second leg to limit a maximum distance between the first leg and the second leg.

5. The bipod system of claim 1, further comprising user controls that receive the user input, wherein the user controls comprise physical control features that facilitate the user input as manual user inputs.

6. The bipod system of claim 5, wherein the user controls comprise a multi-axis joystick.

7. The bipod system of claim 1, further comprising user controls that receive the user input, wherein the user controls comprise a touchscreen that facilitates the user input as one or more of a touch or a gesture.

8. The bipod system of claim 1, wherein the connector comprises a clasp configured to secure the elongated pole to the bipod system by closing around the elongated pole.

9. The bipod system of claim 1, further comprising at least one of a camera, a distance sensor, or a laser pointer to provide user feedback regarding a position of the upper end of the elongated pole.

10. The bipod system of claim 8, wherein the elongated pole and the adjustable bipod system form a tripod.

11. A method, comprising:
extending a telescopic hot stick while secured to an adjustable bipod system, wherein the telescopic hot stick and the adjustable bipod system form a tripod;
maneuvering an upper end of the telescopic hot stick into a target region by adjusting at least one of a first length of a first leg of the adjustable bipod system via a first motor or a second length of a second leg of the adjustable bipod system via a second motor;
performing an operational function with the upper end of the telescopic hot stick in the target region; and
retracting the telescopic hot stick while secured to the adjustable bipod system upon completion of the operational function.

12. The method of claim 11, further comprising securing the telescopic hot stick to the adjustable bipod system by closing a clasp of the adjustable bipod system around the telescopic hot stick.

13. The method of claim 11, wherein at least one of the first length or the second length is adjusted in response to a user input received by an electronic control system associated with the bipod system.

14. A bipod system, comprising:
a first leg comprising a first actuator configured to change the length of the first leg in response to a first control signal;
a second leg comprising a second actuator configured to change the length of the second leg in response to a second control signal;
an elongated pole that is secured to the bipod system via a connector; and
a controller configured to generate the first control signal and the second control signal in response to a user input to move the elongated pole based on a change to the length of at least one of the first leg and the second leg.

15. The bipod system of claim 14, wherein the first actuator is a first linear actuator and the second actuator is a second linear actuator.

16. The bipod system of claim 14, wherein the first leg is coupled to the connector by a first ball joint and the second leg is coupled to the connector by a second ball joint.

17. The bipod system of claim 14, wherein a lower end of the first leg is coupled to a lower end of the second leg by a flexible material that limits a maximum distance between the lower end of the first leg and the lower end of the second leg.

18. The bipod system of claim 14, further comprising user controls that receive the user input, wherein the user controls comprise physical control features that facilitate the user input as manual user inputs.

19. The bipod system of claim 14, wherein the connector comprises a clasp configured to secure the elongated pole to the first leg and to the second leg by closing around the elongated pole.

20. The bipod system of claim 14, wherein the elongated pole is a telescoping pole, the bipod system further comprising a lengthening actuator configured to adjust a length of the telescoping pole in response to a third control signal provided by the controller.
